(19) United States
(12) Patent Application Publication
(10) Pub. No.: US 2025/0328128 A1
(43) Pub. Date: Oct. 23, 2025

(54) METHOD AND DEVICE FOR DETECTING MEASUREMENT DATA OF A MACHINE, AND TIRE HEATING PRESS HAVING A DEVICE FOR DETECTING MEASUREMENT DATA

(71) Applicant: Harburg-Freudenberger Maschinenbau GmbH, Hamburg (DE)

(72) Inventors: Sören FABIAN, Hamburg (DE); Hendrik MEYER, Neu Wulmstorf (DE); Bernd PAPE, Wentorf (DE); Fokko ERDMANN, Adendorf (DE)

(21) Appl. No.: 18/866,506

(22) PCT Filed: May 17, 2023
(86) PCT No.: PCT/DE2023/100366

§ 371 Date: Nov. 15, 2024

(30) Foreign Application Priority Data
May 17, 2022 (DE) 10 2022 112 336.7
Mar. 20, 2023 (DE) 10 2023 106 870.9

(51) Int. Cl. G05B 19/418; B29C 35/02

(52) U.S. Cl. CPC G05B 19/41875; B29C 35/0288

(57) ABSTRACT

A method and a device for acquiring measurement data of a machine and a tire curing press including a device for acquiring measurement data. Measurement data is captured and digitally processed in order to obtain information about the condition of a machine and to derive recommendations for action for maintenance, repair or overhaul as well as process optimization of the machine.

The invention relates to a method and a device for acquiring measurement data from a machine.

Furthermore, the invention relates to a tire curing press comprising at least one device for acquiring measurement data of a machine.

In embodiments, the invention comprises a digital application for machines, in particular for tire curing presses.

Known tire curing presses already have a digital control system that can be used to control the individual process steps, which vary depending on the machine equipment. In addition, many known tire curing presses also have an evaluation unit with which certain functions or malfunctions of the tire curing press can be detected and corresponding machine messages can be generated.

These machine messages must be read and interpreted manually by the user, operator or maintenance personnel for known tire curing presses.

For production machines, including tire curing presses, it is generally important to achieve the shortest possible process runtimes in order to enable a high throughput.

The process runtime is specified for a particular machine configuration and is maintained within a certain tolerance range when a new or wear-and defect-free machine is commissioned in accordance with the specification.

However, during the operation of a machine, wear occurs on the assemblies or components susceptible to wear and defects may occur, which have a negative effect on the realizable process runtime.

Furthermore, it is generally important for production machines, including tire curing presses, to achieve the lowest possible media consumption in order to enable efficient use of media.

The media consumption, for example in the form of the (electrical) energy, compressed air, oil or hydraulic oil, nitrogen, steam or hot water required for a process cycle, is specified for a particular machine and process specification and is maintained within a certain tolerance range when a new or wear-and defect-free machine is commissioned in accordance with the specification.

During the operation of a machine, however, wear occurs on the assemblies or components susceptible to wear as well as possible defects, which can have a negative effect on the realizable media consumption.

It is therefore an object of the invention to create a device for acquiring measurement data from a machine and a tire curing press which solves at least some of the aforementioned problems.

According to the invention, this object is achieved by a device for acquiring measurement data of a tire curing press according to patent claim 1 and a tire curing press according to patent claim 13.

A further object of the invention is to provide a method for acquiring measurement data from a machine which solves at least some of the aforementioned problems.

According to the invention, this object is achieved by a method for acquiring measurement data of a tire curing press according to patent claim 14.

Advantageous aspects of the invention are claimed in the dependent claims.

The following disclosed features of a device for acquiring measurement data from a machine, a tire curing press and a method for acquiring measurement data from a machine are part of the invention in all practicable combinations.

In embodiments of the invention, a digital solution for the condition monitoring of machines, in particular tire curing presses, tire building machines, mixing machines, e.g. for rubber or for machines from food and/or edible oil production, is realized.

A device according to the invention for acquiring measurement data of a machine is designed for monitoring at least one machine and comprises at least one capturing device for capturing at least one machine parameter of the at least one monitored machine and at least one evaluation unit.

The cycle time required to complete a process cycle can be captured as a machine parameter with the aid of the at least one capturing device.

In advantageous embodiments of the invention, at least one subcycle time corresponding to the duration of a defined process step or a defined sequence of process steps can be detected with the aid of the at least one capturing device.

Preferably, the cycle time required to perform a process cycle and at least one subcycle time can be detected with the aid of the at least one capturing device.

In preferred embodiments of the invention, the process cycle is divided into subcycles, wherein each subcycle corresponds to a defined machine movement or a sequence of machine movements.

In particularly advantageous embodiments of the invention, the duration of each of the defined subcycles can be detected with the aid of the at least one capturing device.

To detect the cycle and/or subcycle times, the at least one capturing device is designed to retrieve data from the machine control system and/or to evaluate machine messages and/or to monitor the respective machine using sensors.

The machine control of the at least one monitored machine specifies the start time of a cycle or subcycle with a control command, for example, and recognizes the end time of a cycle or subcycle on the basis of a measured value, for example in the form of the activation of a switch/button when a certain position is reached, to which a further control command is issued to start the next process step.

In corresponding embodiments with the retrieval of data from the machine control system, the at least one capturing device is designed, for example, to detect a first cycle or subcycle time by measuring the time between a first control command initiating the first cycle or subcycle and a second control command initiating the next, second cycle or subcycle, or a detected event signaling the end of the first cycle or subcycle.

In addition, certain machine messages can also correspond to the start or end of a cycle or subcycle, so that the detection of a corresponding machine message using the at least one capturing device can define the start or stop time of a cycle or subcycle.

Furthermore, in embodiments of the invention, the start and end of cycles or subcycles can be detected by sensor-based monitoring of the at least one monitored machine. For example, the start and end of certain process steps can be detected with the aid of imaging monitoring of the at least one machine, in particular when movements are involved.

In various embodiments of the invention, the aforementioned ways of detecting the cycle and/or subcycle times are combined with each other in all possible options.

The at least one evaluation unit of the device according to the invention for acquiring measurement data of a machine is designed to monitor the condition of the at least one monitored machine based on the cycle and/or subcycle times detected with the aid of the at least one capturing device.

In preferred embodiments of the invention, condition monitoring within the meaning of the invention is the specific condition monitoring of the at least one monitored machine as a whole and at component and/or function level. Particularly preferably, condition monitoring is realized at component level.

For condition monitoring, the at least one evaluation unit is preferably designed to retrieve stored set values, tolerances and/or limit values of at least the cycle time, preferably also of all defined subcycles.

For example, the evaluation unit is designed to retrieve the target values from a local storage device as part of the device for acquiring measurement data and/or from an external data storage, for example as part of a cross-machine database at a production site or in the cloud. Preferably, an associated tolerance range or limit value is retrieved for the at least one cycle and/or subcycle time. In principle, it is also possible according to the invention that only the tolerance ranges and/or limit values of all cycle/subcycle times are retrievable.

In addition, the at least one evaluation unit is designed to compare the detected real cycle and/or subcycle times with the setpoint values and/or the tolerance ranges or the limit values for the setpoint values.

If at least one of the detected times falls outside the tolerance range of the target values defined for the overall process and/or the respective process step or exceeds or falls below the respective limit value, the at least one evaluation unit is designed to detect a time deviation.

In embodiments of the invention, when a time deviation is detected, the at least one evaluation unit is designed to generate a deviation signal which signals the deviation of at least one of the detected times.

In embodiments of the invention, the at least one evaluation unit is designed to output the at least one deviation signal when a time deviation is detected.

Preferably, the deviation signals can be individually identified according to the respective cycle or subcycle, so that the deviation signal can be used to determine which cycle/subcycle deviates from the setpoint value or setpoint values.

In embodiments of the invention, the at least one evaluation unit can be used to generate a deviation message that identifies at least the deviating cycle and/or subcycle, depending on the individual deviation between the target time and the actual time.

In embodiments of the invention, the evaluation unit is designed for automated detection of the at least one cause underlying the time deviation or at least for automated delimitation of the possible causes.

The assignment of subcycles to specific process steps or machine movements makes it possible to narrow down the possible causes to those that influence the duration of the respective subcycle based on the identification of the deviating subcycle.

In advantageous embodiments of the invention, the at least one evaluation unit can be used to retrieve cause lists assigned to the individual cycles or subcycles, which contain the various possible causes for the respective time deviation.

Causes for a deviation in the cycle or subcycle time can include wear, defects, incorrect settings, material and/or production faults.

Preferably, at least one criterion is assigned to each cause listed in the cause list, whereby it is possible to determine whether the respective cause applies or can apply by checking the presence or absence of the at least one criterion.

In embodiments of the invention, the at least one evaluation unit with the deviation signal and/or the deviation message is designed to output the respective cause list and/or criteria list.

By collecting additional data, it may be possible to clearly identify the cause from the list of causes or at least further narrow down the list of causes.

Compared to the primary collection and analysis of alarm and fault messages from the machine, monitoring the cycle times of a machine offers the advantage of being able to respond to previously unnoticed, creeping deteriorations in the machine process (“process drift”) at a very early stage. Furthermore, monitoring the cycle times, especially the subcycle times, can support the search for the trigger of an error message if this is not clear.

In advantageous embodiments of the invention, the at least one evaluation unit is designed to retrieve additional data in the event of a detected time deviation, the evaluation of which, in conjunction with the detected time deviation, allows the cause to be automatically identified or at least further narrowed down.

In embodiments of the invention, the at least one evaluation unit is designed to correlate the detected (sub) cycle deviations with the additional retrieved data.

In embodiments of the invention, the additional retrievable data comprises sensor data and/or machine messages and/or media consumption, in each case in relation to the at least one monitored machine and/or corresponding machines.

By evaluating sensor data, which may be provided by machine-related measured values, machine messages and/or media consumption, criteria for the presence or absence of certain causes for the time deviation(s) can be checked in corresponding embodiments of the invention with the aid of the at least one evaluation unit.

In embodiments of the invention, the at least one evaluation unit is designed to automatically generate suggestions for eliminating the cause based on the determined cause or the determined possible causes for the at least one detected deviation and/or to perform an automated cause elimination and/or to output suggestions or instructions for further cause determination.

The sensor-based monitoring of the at least one machine, for example a tire curing press, implemented in embodiments of the invention is realized by means of at least one sensor arranged to acquire data relating to the at least one monitored machine.

The at least one sensor can be an integral part of the at least one machine to be monitored or a sensor arranged in, on or in the area of the at least one machine to be monitored as part of the device for acquiring measurement data.

As such a sensor, in various embodiments of the invention, for example, at least one of the following sensors is arranged for corresponding use: pressure sensor and/or flow sensor (e.g. for steam, air, nitrogen or hydraulic oil) and/or sensor for measuring electrical voltages, currents or power and/or vibration sensor and/or temperature sensor and/or particle monitor and/or humidity sensor and/or viscosity sensor and/or imaging sensor and/or velocity sensor and/or acceleration sensor and/or force sensor and/or sensor for determining valve states.

In embodiments of the invention, the evaluation unit is designed to retrieve and evaluate the sensor data (measured values) of at least one sensor which is arranged to record data relating to the at least one monitored machine.

In embodiments of the invention, the evaluation unit is designed to retrieve and evaluate the sensor data (measured values) when a time deviation occurs. This event-based data retrieval ensures smaller amounts of data to be processed compared to continuous retrieval.

In other embodiments of the invention, the at least one evaluation unit is designed to continuously retrieve the sensor data. The continuous data retrieval provides a comprehensive database that can be used, for example, with the aid of artificial intelligence (AI) and/or machine learning (ML) to predict the condition of the machine.

In embodiments of the invention, it is also possible to combine the retrieval of sensor data when a time deviation occurs for a first group of sensor data comprising at least the sensor data acquired by means of a sensor with a continuous retrieval of the sensor data of a second group of sensor data.

In advantageous embodiments of the invention, target values can be retrieved for the sensor data that can be captured in the respective configuration with the aid of the at least one evaluation unit and the captured sensor data can be compared with the target values. If a measured value is outside any defined tolerances around the setpoint value, a measured value deviation can be determined with the aid of the at least one evaluation unit.

The deviation of the measured values of one or more sensors from the target values may be an indicator of specific causes, errors or defects.

In advantageous embodiments of the invention, a cause list can be retrieved for various measured value deviations or combinations of measured value deviations with the aid of the at least one evaluation unit so that the cause, the error or the defect can be unambiguously identified automatically or the cause list can at least be further restricted automatically with the aid of the at least one evaluation unit.

Various sensors and their arrangement in the monitored system are described below using the application example of a tire curing press, so that they can be used to support the diagnosis of the systems/subsystems mentioned.

In embodiments of the invention, a pressure sensor is arranged for diagnosing the hydraulic system. For example, this is arranged in the pressure line of the hydraulic unit for measuring the hydraulic pressure, so that the hydraulic pressure provided by the hydraulic unit can be checked.

In embodiments of the invention, a pressure sensor is arranged to diagnose the pneumatic system. For example, this is arranged in the central compressed air supply line of the machine for measuring the pressure of the pneumatic system.

In embodiments of the invention, a pressure sensor is arranged for diagnosing the heating media. For example, this is arranged in at least one supply line of the heating media (steam, nitrogen, hot water, etc.) for measuring the pressure. The pressure in the supply line has an effect, for example, on the vulcanization process (product quality) and the condition of the heating system (wear of heating valves, etc.).

In embodiments of the invention, a flow sensor is arranged to diagnose the hydraulic system. For example, this is arranged in the pressure line of the hydraulic unit for measuring the flow rate of the hydraulic oil. With the aid of this arrangement, the condition of the hydraulic system can be checked for leaks, among other things.

In embodiments of the invention, a flow sensor is arranged for diagnosing the pneumatic system. For example, this is arranged in the central compressed air supply of the machine for measuring the flow rate/quantity of compressed air of the pneumatic system. With the aid of this arrangement, the condition of the pneumatic system can be checked for leaks, among other things.

In embodiments of the invention, a flow sensor is arranged for diagnosing the heating media. For example, this is arranged in at least one supply line of the heating media (steam, nitrogen, hot water, etc.) for measuring the flow rate/quantity of the heating media. The pressure in the supply line affects, for example, the vulcanization process (product quality) and the condition of the heating system (wear of heating valves, etc.) and the condition of the rubber bladder.

In embodiments of the invention, a power meter is arranged for diagnosing the hydraulic system. For example, this is integrated into the electrical supply of the hydraulic unit in the control cabinet so that the power consumption (motor currents, voltage) of the hydraulic unit can be monitored. The power consumption of the hydraulic unit is influenced, for example, by wear on the hydraulic unit and/or the condition of the hydraulic system.

In embodiments of the invention, a power meter is arranged for diagnosing the servo swivel drives, for example of the at least one loading and/or unloading device of a corresponding tire curing press. For example, this is integrated into the electrical supply of the servomotors for measuring the electrical characteristics (voltage, currents, power consumption). This arrangement makes it possible, for example, to determine the function and condition of the swivel mechanism (wear on bearings, gears, etc.).

In embodiments of the invention, a vibration sensor is arranged for diagnosing the hydraulic system. For example, this is arranged on the motor housing of the hydraulic unit so that the vibrations of the motor can be monitored during operation. This arrangement makes it possible, for example, to detect wear on the hydraulic unit, in particular with regard to the motor or the pump.

In embodiments of the invention, a temperature sensor is arranged to measure the ambient temperature of the machine. For example, this is arranged on the control cabinet. The ambient temperature can be used, for example, as a reference for the other process parameters of the machine (e.g. oil temperature, external heating temperature, condensation steam lines).

In embodiments of the invention, a temperature sensor is arranged to measure the temperature of the green tire. For example, this is arranged on the blank stand and/or on the loading mechanism for measuring the external temperature of the tire blank. The blank temperature influences the vulcanization process and the product quality.

In embodiments of the invention, a temperature sensor is arranged to measure the temperature of the vulcanized tire. For example, this is arranged on the unloading mechanism for measuring the external temperature of the tire. The tire temperature is influenced by the vulcanization process and affects the product quality.

In embodiments of the invention, a temperature sensor is arranged in the PCI (post-treatment device for a vulcanized tire) to measure the temperature of the tire. For example, this is arranged in the respective cell of the PCI for measuring the external temperature of the tire. This arrangement makes it possible to monitor the effects of the tire temperature on the PCI function/product quality.

In embodiments of the invention, a temperature sensor is arranged on the conveyor belt to measure the temperature of the tire. For example, this is arranged on the storage locations of the conveyor belt to measure the external temperature of the tire. This arrangement makes it possible to monitor the effects of the tire temperature on the product quality and/or the subsequent processes in the value chain.

In embodiments of the invention, a particle monitor is arranged to monitor the hydraulic system. For example, this is arranged in the tank of the hydraulic unit for detecting particles, such as air inclusions or metal particles, in the hydraulic oil. With the aid of this arrangement, the oil quality and the condition of the hydraulic system can be monitored.

In embodiments of the invention, a humidity sensor is arranged to monitor the rubber bladder. For example, this is arranged in the heating device to detect bladder leakage during operation. This arrangement allows the condition of the bladder (wear part) to be monitored during production.

In embodiments of the invention, a viscosity sensor is arranged to monitor the hydraulic system. For example, this is arranged in the tank of the hydraulic unit for measuring the viscosity of the hydraulic oil. With the aid of this arrangement, the oil condition (including ageing, etc.) and the condition of the hydraulic system can be monitored.

In embodiments of the invention, a sensor for the use of imaging methods is arranged to monitor the rubber bladder. For example, this is arranged in front of the heating device with different flashing angles on the bladder for monitoring the geometry of the bladder during operation. With the aid of this arrangement, the condition of the bladder (wear part) can be monitored during production.

In embodiments of the invention, a sensor for the use of imaging methods is arranged to monitor the wear of the mold/sliding plates. For example, this is arranged in front of the heating device with different flashing angles on the mold segments/sliding plates for monitoring the geometry of the mold segments/sliding plates.

In embodiments of the invention, a speed and/or acceleration sensor is arranged to monitor a swivel drive of a loading and/or unloading device. For example, this is arranged on the swivel arm for monitoring the movement profile (speed, acceleration) of the swivel arm. With the aid of this arrangement, wear or incorrect adjustment of the swivel mechanism can be detected.

In embodiments of the invention, a speed and/or acceleration sensor is arranged to monitor the vertical movement of the loading and/or unloading device. For example, this is arranged on the swivel arm for monitoring the movement profile (speed, acceleration) of the lifting mechanism so that wear or incorrect adjustment of the lifting mechanism can be detected.

In embodiments of the invention, a speed and/or acceleration sensor is arranged to monitor the vertical movement of the PCI cells. For example, this is arranged on a lifting cylinder for monitoring the movement profile (speed, acceleration) of the lifting mechanism so that wear or incorrect adjustment of the lifting mechanism can be detected.

In embodiments of the invention, a speed and/or acceleration sensor is arranged to monitor the vertical movement of the head part (upper part of the press). For example, this is arranged on the head part for monitoring the movement profile (speed, acceleration) of the head part so that wear or incorrect adjustment of the lifting mechanism can be detected.

In embodiments of the invention, a force sensor is arranged to monitor a swivel drive of a loading and/or unloading device. For example, this is arranged on the swivel arm for monitoring the force curve during swiveling. With the aid of this arrangement, wear or incorrect adjustment of the swivel mechanism can be detected.

In embodiments of the invention, a force sensor is arranged to monitor the bladder expansion cylinder. For example, this is arranged on the bladder expansion cylinder for monitoring the force curve of the bladder expansion cylinder during production, so that wear detection or detection of incorrect setting/configuration is possible.

In embodiments of the invention, a force sensor is arranged to monitor the segment mold actuation. For example, this is arranged on the stroke cylinder of the segment mold actuation for monitoring the force progression of the segment mold actuation in production, so that wear detection of the mold or the segment mold actuation or detection of incorrect setting/configuration is possible.

In embodiments of the invention, the at least one evaluation unit is designed to retrieve and evaluate machine messages from the at least one monitored machine.

Machine messages are messages that are generated automatically by the control system of the respective machine, usually depending on the status. In particular, alarm and/or fault messages are such machine messages, but these can also include general status messages, for example.

Depending on the monitored machine and machine software/PLC software, there are between 500-1,500 different machine messages, for example. These are currently not standardized in their type and error code and depend on individual customer specifications and the respective machine control system. In preferred embodiments of the invention, these machine messages are so precise and specific that the user can directly determine the cause/source of the error from them and may even receive instructions for action.

In embodiments of the invention, the at least one evaluation unit is designed to retrieve and evaluate machine messages from the at least one monitored machine when a time deviation occurs.

In other embodiments of the invention, the at least one evaluation unit is designed to continuously retrieve the machine messages of the at least one monitored machine. The continuous data retrieval provides a comprehensive database that can be used, for example, with the aid of AI and/or ML for predictions of the machine condition.

A combination of the retrieval of machine messages when a time deviation occurs for a first group of machine messages with a continuous retrieval of the machine messages of a second group is also possible in embodiments of the invention.

In embodiments of the invention, the at least one evaluation unit is designed to count and store the frequencies of occurrence of at least one specific machine message. Depending on the machine message and its frequency or the trend of the frequency in embodiments of the invention, this is an indicator of the need for a maintenance measure.

In embodiments of the invention, the at least one evaluation unit is designed to determine and/or store the maximum, minimum and/or average duration of the occurrence of specific machine messages, the assignment of machine messages to a specific product ID and/or the assignment of machine messages to specific assemblies or parts of the at least one monitored machine.

In embodiments of the invention, the at least one evaluation unit is designed to retrieve and evaluate the consumption of at least one consumption medium of the at least one monitored machine.

In embodiments, the consumption of the following exemplary consumption media can be retrieved using the evaluation unit: the electrical energy required for a cycle or a subcycle, the amount of compressed air, oil or hydraulic oil, nitrogen, water, steam or hot water required.

In embodiments of the invention, the evaluation unit is designed to retrieve and evaluate the consumption of at least one consumption medium when a time deviation occurs.

In other embodiments of the invention, the at least one evaluation unit is designed to continuously retrieve the consumption of at least one consumption medium.

In embodiments of the invention, it is also possible to combine the retrieval of the media consumption when a time deviation occurs for a first group of media consumptions with a continuous retrieval of the media consumption of a second group of media consumptions.

In advantageous embodiments of the invention, setpoint values can be retrieved for the at least one media consumption that can be retrieved in the respective configuration with the aid of the at least one evaluation unit and the recorded media consumption can be compared with the setpoint values. If a consumption value is outside any defined tolerances around the setpoint value, a consumption deviation can be determined with the aid of the at least one evaluation unit.

The deviation of at least one media consumption from the target values may be an indicator of specific causes, faults or defects.

In advantageous embodiments of the invention, a cause list can be retrieved for various consumption deviations or combinations of consumption deviations with the aid of the at least one evaluation unit so that the cause, the fault or the defect can be unambiguously identified automatically or the cause list can at least be further restricted automatically with the aid of the at least one evaluation unit.

In embodiments of the invention, the device for acquiring measurement data from a machine has at least one communication device for connecting to at least one additional data source and/or for transmitting data to a higher-level storage and/or evaluation unit, which is/are preferably designed for data storage and/or evaluation for several machines.

In embodiments of the invention, additional data sources are, for example, other machines, preferably of the same machine type, which are, for example, of identical or almost identical construction, processes or devices arranged along the value chain upstream or downstream of the at least one monitored machine, a central storage and/or evaluation unit which, for example, has greater resources for carrying out extensive data evaluations or can access a larger amount of data, design data of the at least one monitored machine and/or the CAD model of the at least one monitored machine.

The central storage and/or evaluation unit can, for example, be implemented on a local server, in particular at the installation site (e.g. production site) of the at least one monitored machine, and/or on a cloud server.

The use of a central storage and/or evaluation unit saves additional capacities for data processing on each individual machine and, in embodiments of the invention, makes it possible to display the results of the data evaluation via mobile data technology regardless of location, as well as local, regional or global benchmarking of various monitored machines.

In embodiments of the invention, the at least one evaluation unit is designed to carry out a benchmark—i.e. the data-based comparison of several monitored machines (e.g. tire curing presses) locally in one plant, regionally for several plants and globally across many/all plants.

This offers the following advantages for the operator or manufacturer of the monitored machines:

From the (local or global) comparison with identical machines, conclusions can be drawn about the condition of the machine, if necessary taking into account the respective product configuration. In embodiments of the invention, this is done automatically.

From the (local or global) comparison with machines of other designs, possibly taking into account the respective product configuration, conclusions can be drawn about possible design improvements and/or process improvements. In embodiments of the invention, this is done automatically.

Conclusions about the performance of a factory can be drawn from the derived values for productivity and availability and their local, regional or global comparison. These can be made available to different user groups according to differentiated access authorizations and in anonymized form. In embodiments of the invention, this is done automatically.

In embodiments of the invention, the integration of upstream process steps in product manufacture (e.g. mixer, extrusion and tire building in tire manufacture) and downstream process steps (e.g. quality control) can be used for diagnosing the machine condition and/or the product quality of the individual product (e.g. tires) with the aid of the at least one evaluation unit.

In embodiments of the invention, for example, the tire structure is specified by information on the dimensions of the (green) tire (e.g. diameter and width), the weight, the composition of the rubber compound(s) of the green tire and/or the (layer) structure of the green tire and can be retrieved from a data source with the aid of the at least one evaluation unit. This means, for example, that the specified weight of the green tire can be taken into account as an influencing factor on the duration of certain movements in terms of subcycles.

In exemplary embodiments of the invention, feedback from quality control to a monitored tire curing press is established to provide a basis for the effects of the tire curing press process parameters on product quality.

In embodiments of the invention, product-related data can be made available in consideration of the entire value chain by integrating the other process steps of the value chain.

For example, in corresponding embodiments of the invention, the energy requirement and/or the material requirement for the production of a tire can be identified. The data basis can in turn be used for maintenance management to optimize machine operation and/or troubleshooting and/or further product development of the manufactured product.

Furthermore, in embodiments of the invention, methods of machine learning and/or artificial intelligence are applied to the process- and machine-relevant data of the entire value chain, for example in order to be able to determine a forecast of the product quality of a tire on the basis of process data. Accordingly, in corresponding embodiments of the invention, the need for quality assurance measures at the end of the value chain can be reduced.

In embodiments of the invention, the evaluation unit and the data evaluated over time with the evaluation unit are used to implement condition monitoring with condition prediction in the interaction of condition parameters and the operating behavior in certain situations using statistical methods/predictions.

In embodiments of the invention, the at least one evaluation unit is designed to apply methods of artificial intelligence (AI) and/or machine learning (ML) to the retrievable data. By evaluating large amounts of data, correlations between changes and/or trends in individual data and the occurrence of certain causes of faults can thus be determined, so that in embodiments of the invention future conditions of the at least one monitored machine can be predicted.

In embodiments of the invention, this enables the early issue of warning messages regarding impending defects and/or required maintenance.

In embodiments of the invention, the condition of the at least one monitored machine, for example a tire curing press, can be displayed in a digital application (app).

In embodiments of the invention, the determined indicators can be output as an optical display by means of digital end devices. Digital end devices in this sense are, for example, smartphones, smartwatches, tablets, notebooks, PCs or digital display panels.

In embodiments of the invention, current alarm and/or fault messages for a machine can be displayed at a glance, including symbolic criticality, message designation and time stamp.

In embodiments of the invention, details of individual alarm and/or fault messages relating to a machine can be displayed with a name, description, solution notes, references to the same message on other machines with a time stamp and/or a link to the product produced under fault conditions (e.g. tire ID).

In embodiments of the invention, a message overview of several monitored machines (e.g. tire curing presses) can be output with a symbol for criticality, designation, machine location (“trench”), machine number and/or time stamp.

In embodiments of the invention, the comparison and simultaneous display of fault messages from several machines (e.g. tire curing presses) in a factory provides the maintenance management with a control station for maintenance, which makes the currently necessary maintenance measures for all monitored machines (e.g. tire curing presses) transparent. This data basis can be used to derive priorities for maintenance and servicing and to identify interrelated malfunctions of several machines against the background of the common infrastructure (e.g. group hydraulics, heating media, etc.).

In preferred embodiments of the invention, the last approximately 10 cycle times of a monitored machine or a monitored group of machines (e.g. heating press or group of heating presses, e.g. trench/entire heating chamber), which can be flexibly adjusted as required, can be displayed as an overview during operation and can be set in relation to the specification of the tire produced. If the actual cycle time is higher than the target cycle time, the deviation and, if necessary, optional instructions for checking and/or optimally setting relevant assemblies or individual functions can be output as a message. Precise threshold values and tolerance ranges for the monitored machine parameters can be defined for the respective machine configuration. The message function can be (de) activated. In embodiments of the invention, the operating data for the relevant assemblies or individual functions can be displayed in detail.

In advantageous embodiments of the invention, the at least one evaluation unit can be used to automatically propose improvement measures for the at least one monitored machine based on the evaluated data.

In embodiments of the invention, this solution approach can be used, for example, to improve machine performance by keeping the cycle times or cycle times, for example of tire curing presses, stably low in order to increase productivity.

In embodiments of the invention, the at least one evaluation unit can be used to generate early warnings based on evaluated data, which increase machine availability by avoiding unplanned downtimes, supporting repair and maintenance measures and/or reducing the consumption of spare parts.

In embodiments of the invention, the digital solution approach makes it possible to display the energy consumption of the at least one monitored machine, for example a tire curing press, in production and thus make it accessible to a user or operator of the machine for measures to improve energy consumption/the CO2 footprint.

In embodiments, the invention provides the following advantages or has the following features individually or in combination:

Optimizing the performance of the machine, monitoring and stabilizing the cycle time of machines, e.g. tire curing presses, at a low level, issuing early warning messages when the cycle time exceeds a certain threshold, indicating causes for a continuous and gradual increase in cycle time, such as undetected leaks, wear or incorrect settings, reducing the actual cycle time by an average of up to 10-20 seconds per tire curing press and cycle, increasing the productivity of a tire curing press by around 600-1800 tires per year (+1-3%).

In embodiments of the invention, improved machine availability is made possible. This is achieved in particular by the following measures individually or in practicable combinations:
Reduction of unplanned downtimes through early warning of incidents such as leaks, wear and tear,
Avoidance of unnecessary cooling and preheating by reducing unplanned downtimes,
Shortening repair times by identifying the causes of faults and thus supporting targeted countermeasures,
Reduction of planned maintenance times by focusing the measures on problems that need to be rectified,
Optimization of spare parts consumption through condition-based replacement of spare parts,
Lower operating costs by reducing repair and maintenance times and avoiding idle costs,
Reduction of energy costs through real-time monitoring and reduction of unnecessary energy consumption,
An overall reduction in costs per vulcanized tire of 1-3%.

In embodiments of the invention, intelligent vulcanization of a tire is implemented.

In embodiments of the invention, the so-called “Smart Curing” comprises the data exchange with tire curing presses in the entire curing area as well as the necessary database for recording production and process data. This system enables simultaneous production monitoring, traceability, recipe management and analysis of the tire curing presses.

In embodiments of the invention, a control loop is implemented that intervenes in the machine control system depending on the detected time deviation or the identified cause of the time deviation (e.g. automatic provision of digital parameters in the machine PLC, change of configurations) or uses mechanical actuators for targeted intervention in the system to be controlled, so that a “self-healing” tire curing press is implemented.

Areas of application include production monitoring (e.g. production plan vs. actual, OEE, TCO), process monitoring (e.g. vulcanization data acquisition, recipe management, quality assurance), machine monitoring (e.g. condition monitoring, predictive maintenance, alarm diagnostics, machine service), energy monitoring (e.g. electricity, compressed air, oil, curing agents).

In embodiments of the invention, applied technology/methods include, for example, sensor technology, actuator technology, PLC programming and control, IT networking of machines (e.g. tire curing presses), edge/fog, edge/fog computing, IIoT gateways, Internet connection/protocols, cloud technology, data analysis, mobile application, machine learning algorithms/artificial intelligence, virtual reality and/or augmented reality.

According to the digital solution approach for the condition monitoring of machines (e.g. tire curing presses) according to the invention, it is possible in embodiments of the invention to display the condition of a machine in a digital app and to automatically suggest improvement measures to the operating and maintenance personnel, as well as to enable technologically self-healing, self-regulating measures of the machine in production.

Areas of application include production monitoring (e.g. keeping the cycle times of tire curing presses stable and low in order to increase productivity by outputting deviations between predetermined target and measured actual values in the cycle time of (partial) phases of the tire curing process), process monitoring (e.g. using machine alarm messages and machine parameters to indicate quality defects in the tire vulcanization process, whereby the monitoring of vulcanization cycle times provides support to prevent previously unnoticed process deviations that would otherwise lead to a continuous increase in cycle times in the tire vulcanization process), machine monitoring/controlling (e.g. by correlating cycle time deviations with machine parameters and/or fault messages. In this way, automated indications of the causes of faults can be derived and automated suggestions for troubleshooting can be made.

In embodiments of the invention, a digital maintenance tool for machines (e.g. for tire curing presses) is realized.

In embodiments of the invention, a method and a device for the efficient and effective maintenance of machines (e.g. tire curing presses) is realized for this purpose.

In embodiments of the invention, the method and the device are based on the principles of digital condition monitoring and/or artificial intelligence.

In embodiments of the invention, the at least one evaluation unit is designed to detect wear or defects in at least one assembly, such as the hydraulic unit, the pneumatic unit, a loading and/or unloading device, a closing unit or a safety scanner.

In preferred embodiments of the invention, the at least one evaluation unit is designed to detect wear or defects in at least one component as such or as part of an assembly, such as a shock absorber, hydraulic cylinder, motor, line (leakage/blockage) or sensor.

In embodiments of the invention, the at least one evaluation unit is designed to detect wear or defects in at least one hydraulic unit. For this purpose, in embodiments of the invention, the evaluation unit is designed to detect cycle or subcycle times which are directly or indirectly influenced by the state of the hydraulic unit and/or to detect the hydraulic pressure using at least one pressure sensor and/or to evaluate machine messages and/or the control parameters (configuration) relating to the hydraulic unit.

In embodiments of the invention, the at least one evaluation unit is designed to detect defects and/or wear in the pressure regulator of at least one hydraulic unit. If the pressure regulator of the hydraulic unit is defective or worn, a different pressure, usually a reduced pressure, is provided instead of the set pressure. This slows down hydraulically realized movements of the machine so that the corresponding cycle and/or subcycle times become longer.

In embodiments of the invention, the at least one evaluation unit can be used to retrieve a list of causes based on a detected deviation of a cycle or subcycle time with a possible cause in the hydraulic system, for example comprising the causes wear of the hydraulic unit, leakage in the hydraulic system, faulty actuation of the hydraulic unit, faulty adjustment of the hydraulic system and wear of the hydraulic cylinders.

In advantageous embodiments of the invention, criteria for the individual possible causes can be retrieved and preferably automatically checked with the aid of the at least one evaluation unit in order to automatically narrow down the at least one cause underlying the at least one detected deviation.

For example, in embodiments of the invention, one or more of the following criteria can be retrieved and preferably checked: Pressure in the pressure line of the hydraulic unit, electrical parameters (currents, voltages, power consumption) on the hydraulic unit, temperature of the hydraulic oil, oil level of the hydraulic unit, flow rate in the hydraulic line of the hydraulic unit (leakage detection), vibrations on the motor of the hydraulic unit, machine messages for timeout for hydraulic movements or temperature warning hydraulic oil, data of the upstream and/or downstream value chain.

Based on the summary of the fulfilled or unfulfilled criteria, in corresponding embodiments of the invention, the at least one cause can be clearly determined automatically with the aid of the at least one evaluation unit, or the list of causes can at least be further reduced.

In embodiments of the invention, the at least one evaluation unit is designed to detect defects and/or wear of the closing unit of a tire curing press. In embodiments of the invention, a defect/wear of the closing unit can be detected by evaluating the cycle and/or subcycle times and/or by monitoring the energy consumption of the hydraulic unit and/or by evaluating machine messages.

In embodiments of the invention, the at least one evaluation unit can be used to retrieve a list of causes based on a detected deviation of a cycle or subcycle time with a possible cause in relation to the closing unit, for example comprising the causes lack of lubrication of sliding platens or mold segments of the tire mold, hydraulic leakage at the segment mold actuation, incorrect actuation of the hydraulic function for closing the press (configuration), incorrect setting of the hydraulic function for closing the press (for example setting of the pressure relief valve).

In advantageous embodiments of the invention, criteria for the individual possible causes can be retrieved and preferably automatically checked with the aid of the at least one evaluation unit in order to automatically narrow down the at least one cause underlying the at least one detected deviation.

For example, in embodiments of the invention, one or more of the following criteria can be retrieved and preferably checked: Pressure in the pressure line of the hydraulic unit, hydraulic closing pressure provided, electrical parameters (currents, voltages, power consumption) on the hydraulic unit, temperature of the hydraulic oil, flow rate in the hydraulic line of the hydraulic unit (leakage detection), oil level of the hydraulic unit, vibrations on the motor of the hydraulic unit, machine messages for timeout for the closing process, data of the upstream and/or downstream value chain.

Based on the summary of the fulfilled or unfulfilled criteria, in corresponding embodiments of the invention, the at least one evaluation unit can be used to automatically and unambiguously determine the at least cause or at least further reduce the list of causes.

In embodiments of the invention, the at least one evaluation unit is designed to detect defects and/or wear of the safety scanner at least one machine.

For example, contamination of the safety scanner of machines designed as tire curing presses leads to irregular machine stops. If such a machine stop occurs during the vulcanization of a tire, this usually leads to an over-vulcanized tire and thus to rejects.

In embodiments of the invention, the at least one evaluation unit is designed to detect a defect and/or wear of the safety scanner of at least one machine by evaluating machine messages.

In embodiments of the invention, the at least one evaluation unit is designed to detect a disconnection of at least one sensor of at least one machine.

Sensors can be disconnected, for example, if the sensor cable breaks.

In embodiments of the invention, the at least one evaluation unit is designed to detect an interruption in the connection of at least one sensor of at least one machine by evaluating machine messages and/or evaluating cycle and/or subcycle times.

In embodiments of the invention, the at least one evaluation unit is designed to guide detection of necessary maintenance measures.

In embodiments of the invention, the at least one evaluation unit is designed to evaluate machine messages and/or to evaluate the current process step in the process cycle.

For example, the at least one evaluation unit is designed to evaluate the machine messages for an enable signal, particularly in the case of a tire curing press, and to compare the enable signal with the current process step of the process cycle. If the release signal is not detected during the vulcanization process step, the machine is malfunctioning.

In embodiments of the invention, the at least one evaluation unit is designed to monitor downtimes of at least one machine. In embodiments of the invention, the development of downtimes, in particular their increase, is also an indicator of the need for a maintenance measure.

In embodiments of the invention, the at least one evaluation unit is designed to monitor sensor signals and/or messages from the safety system of at least one machine.

In embodiments of the invention, the at least one evaluation unit is designed to evaluate light barrier signals. Light barriers are often used to secure safety zones around machines, for example around tire curing presses. As soon as a light barrier is triggered, the machine is stopped.

The invention enabled the visualization of corresponding triggers of the safety system via machine messages and/or cycle interruptions.

In embodiments of the invention, the at least one evaluation unit is designed to detect defects and wear of at least one pneumatic unit. For this purpose, in embodiments of the invention, the evaluation unit is designed to detect cycle or subcycle times which are directly or indirectly influenced by the state of the pneumatic unit and/or to detect the pneumatic pressure using at least one pressure sensor and/or to evaluate machine messages relating to the pneumatic unit.

In embodiments of the invention, the at least one evaluation unit is designed to detect defects in the compressed air supply of the pneumatic system of at least one machine. For this purpose, in preferred embodiments of the invention, the evaluation unit is designed to monitor the pressure in the pneumatic system and/or in the compressed air supply.

In embodiments of the invention, the at least one evaluation unit is designed to detect wear on at least one loading and/or unloading device at least one machine. For this purpose, in embodiments of the invention, the evaluation unit is designed to detect cycle or subcycle times which are directly or indirectly influenced by the state of the loading and/or unloading device and/or to evaluate machine messages relating to the loading and/or unloading device.

For example, there may be mechanical problems (e.g. on the shock absorber) on the loading and/or unloading device, which result in the loading and/or unloading device not moving into the correct position.

In embodiments of the invention, the at least one evaluation unit is designed to detect wear on at least one loading and/or unloading device of at least one machine.

In embodiments of the invention, the evaluation unit is designed to detect an oil leak on at least one machine. An oil leak can occur, for example, at connection points or a crack/hole in the oil line.

In embodiments of the invention, the at least one evaluation unit is designed to detect an oil leak on at least one machine by evaluating machine data of the hydraulic unit (e.g. oil level, energy consumption).

A machine according to the invention has at least one device according to the invention for acquiring measurement data of a machine.

A tire curing press according to the invention has at least one device for acquiring measurement data of a machine according to the invention.

A method for acquiring measurement data of a machine according to the invention comprises at least the following steps:
Detection of at least one cycle and/or subcycle time of at least one monitored machine,
Automatic comparison of the at least one detected cycle and/or subcycle time with target values,
Automatic detection of a time deviation that exceeds defined tolerances,
Implementation of automated condition monitoring of the at least one monitored machine based on detected time deviations of the cycle and/or subcycle time.

In preferred embodiments of the invention, a cause list comprising possible causes for the detected deviation is then automatically loaded based on the at least one detected time deviation.

In embodiments of the invention, the retrieved cause list is then automatically output.

In embodiments of the invention, an automatic check of the possible causes of the cause list for the detected time deviation is carried out using at least one criterion for unambiguous identification of the at least one cause or for narrowing down the cause list.

In embodiments of the invention, the identified cause/causes or the narrowed down list of causes is then automatically output.

In embodiments of the invention, suggestions for action and/or instructions for action to remedy the at least one identified cause are automatically retrieved afterwards.

In embodiments of the invention, the suggested actions are then automatically output and/or defined instructions for remedying the at least one cause are automatically implemented.

In embodiments of the invention, data is automatically loaded from at least one additional data source in parallel with the monitoring of the cycle and/or subcycle times or after the detection of a time deviation and is used for the automatic unambiguous identification of the at least one cause or for narrowing down the list of causes on the basis of predefined criteria.

In embodiments of the method according to the invention, it is designed as a method for acquiring measurement data of at least one tire curing press.

In preferred embodiments of the method according to the invention, at least one device for acquiring measurement data of a machine according to the invention, a machine according to the invention and/or a tire curing press according to the invention is used.

In embodiments of the invention in which a digital maintenance tool for machines (e.g. for tire curing presses) is realized, the following method steps and/or features are used in the corresponding methods or devices in their entirety or in practicable combinations.

A method according to the invention for digital condition monitoring for the cycle times of a machine (e.g. a tire curing press) is described below in an embodiment according to the invention using the example of a tire curing press.

Monitoring the cycle of a tire curing press to produce a tire from start to finish provides information on whether the machine in question meets production requirements and design specifications. Monitoring the cycle over time on the basis of individual sections or even individual movements provides detailed information on the condition of a tire curing press: Early detection of possible machine faults, localization of problem areas and causes of problems during fault analyses as well as information on preventive maintenance.

Whenever the target and actual time of a section or an individual machine movement in the production cycle deviate beyond a specific tolerance range, this is an indicator of a certain number of possible faults and causes of faults.

In embodiments of the invention, the determined indicators are displayed by means of digital end devices (e.g. smartphones, smartwatches, tablets, notebooks, PCs, digital display panels).

This cycle time monitoring based on individual movements and the resulting support for error analysis and rectification is the focus of this embodiment of the invention.

In embodiments of the invention, this detailed cycle time monitoring is supplemented by
a link to the collection and analysis of alarm and fault messages from the machine,
the sensor-based monitoring of individual components,
the data-based comparison of several tire curing presses with one another (“benchmarking”, creation of data-based “collections of experience”/“knowledge pools”/“case databases”),
Machine learning (ML)/artificial intelligence (AI) algorithms to predict the future behavior of the machine,
3D visualization techniques in the sense of augmented reality or virtual reality.

In embodiments of the invention, a control loop is also set up with the aid of data technology and actuators, so that the diagnostics/analysis described above is supplemented by “self-healing”, self-regulating measures.

In embodiments of the invention, the cycle times of a machine (e.g. tire curing press) are monitored.

In embodiments of the invention, the last (about 4-5; possibly flexibly adjustable) cycle times of a tire curing press or a group of tire curing presses (trench/entire heating room) are displayed as an overview during operation and set in relation to the specification of the tire produced. If the actual cycle time is higher than the target cycle time, the deviation and, preferably, instructions for checking and optimally setting relevant assemblies or individual functions are output as a message. Precise threshold values and tolerance ranges are predefined.

In embodiments of the invention, the signaling function can be (de)activated. If required, the operating data for the relevant assemblies or individual functions can be displayed in detail.

In embodiments of the invention, if the total cycle time is not within the target, instructions are given for checking subsystems (e.g. supply pressure for hydraulics or pneumatics) and/or instructions are given for checking assemblies or individual functions that are not within the target/in a fault state and have a relevant influence on the respective (process) phase.

Depending on the machine equipment and relevant function, the power/adjustment in embodiments of the invention is checked manually or automatically by sensors and adjusted manually or automatically by actuators.

For troubleshooting by the machine operator's maintenance technicians, in embodiments of the invention, suggestions for measures for problem analysis and elimination are automatically assigned in advance to the indications of deviating cycle times by the know-how of machine experts and, if necessary, made available via a condition monitoring solution.

In embodiments of the invention, this is coupled with a technical quick guide (possibly also with a link to online training) and is supported by component-specific data from the condition monitoring.

If a technician is unable to improve the cycle time based on the instructions, further analysis by machine experts is required. In embodiments of the invention, the processing of the instructions is documented digitally.

In embodiments of the invention, the operating data of all assemblies or individual functions is stored long-term and accessible to machine experts for statistical evaluations.

In embodiments of the invention, the cycle time monitoring and the associated target/actual comparison of movement times are used to derive key figures for the productivity and/or availability of the machines.

In embodiments of the invention, average values of past cycles and forecasts for future cycles are generated for each individual movement either from statistical methods or with the aid of machine learning algorithms.

In embodiments of the invention, the determined cycle times are displayed in tabular form (e.g. as total duration and duration per section), in embodiments of the invention in tabular form in detail (i.e. all individual movements of a phase) or in a graphical display form, for example as a diagram (e.g. as duration of the entire cycle and duration of individual phases).

In embodiments of the invention, key figures for productivity and availability are derived in conjunction with the collection and analysis of alarm and fault messages from the machine.

The combination of cycle time monitoring and the collection and analysis of alarm and fault messages realized in embodiments of the invention offers considerable advantages.

If a machine (e.g. a tire curing press) is not equipped with the sensor technology required for condition monitoring, in embodiments of the invention, this is derived indirectly from the operating behavior (actual values) and its development (trends).

In embodiments of the invention, all alarm and fault messages are stored in long-term memory for statistical analysis and can be accessed by machine experts.

In embodiments of the invention, the processing of the messages is digitally documented, ideally according to a predefined scheme, in order to be able to create long-term analyses/correlations. The aim is to be able to carry out analyses of the operating behavior of the machine from the most detailed possible recording of the alarm/error message (fault analytics) and corrective measures taken (maintenance/action log file) and a statistical evaluation. In the course of time, in embodiments of the invention, condition monitoring is realized in the interaction of condition parameters [explicit information via sensors] and the operating behavior in certain situations using statistical methods/predictions.

In embodiments of the invention, an overview of current alarm and fault messages for a machine is displayed, including symbolic criticality, message designation and time stamp.

In embodiments of the invention, details of an individual alarm and fault message for a machine are displayed with a name, description, solution notes, references to the same message on other machines with a time stamp and a link to the product produced under fault conditions (product ID).

In embodiments of the invention, a message overview of several machines (e.g. tire curing presses) is output with an overview of the criticality, designation, machine location (“trench”), machine number and/or time stamp.

In embodiments of the invention, individual components of the at least one monitored machine are monitored by sensors.

In embodiments of the invention, if the sensor system used reports a status value outside the respective tolerance range defined for the component in question, an alarm or fault message is sent in the machine. This is then incorporated into the solution according to the invention.

Conversely, the inclusion of sensor values in embodiments of the invention serves to localize and check for plausibility of the causes of temporal deviations in the cycle time and of alarm and fault messages.

In embodiments of the invention, the (local or global) comparison of alarm and fault messages from machines (e.g. tire curing presses) is used to draw conclusions about possible design improvements and/or process improvements.

In embodiments of the invention, machine learning (ML)/artificial intelligence (AI) algorithms are used to predict the future behavior of the machine.

In embodiments of the invention, average values of past cycles and forecasts for future cycles are generated for each individual movement either from statistical methods or with the aid of machine learning algorithms. Various statistical methods and machine learning algorithms can be used for this purpose, which can also be combined with and among each other.

The procedures differ essentially in how many input parameters, comparison/training data and result parameters can and must be treated with them.

Input parameters are, for example: recipe parameters, machine parameters, cycle times, alarm and fault messages and/or sensor data.

Many data sets for the input parameters are required to check the validity of the statistical methods and to “teach” the ML algorithms. In embodiments of the invention, the results of the method and methods are each compared with the next actual result. In embodiments of the invention, this repeated comparison is used to determine the appropriate statistical method or to train the ML model.

Result parameters are, for example, future cycle times, alarm and fault messages and/or machine conditions (sensor data to be measured).

The quality of the predictions depends on the “training scope” with exemplary data. The quality of the prediction naturally decreases the further into the future one looks.

In embodiments of the invention, 3D visualization techniques in the sense of augmented reality or virtual reality are used.

Using 3D visualization techniques in the sense of augmented reality or virtual reality, the invention enables visual navigation around and “through” the machine in corresponding embodiments, including zooming in and out for detailed or overview views. Furthermore, machine movements can be displayed dynamically and thus simulated using 3D visualization techniques. This supports the tracking of information through data analysis and the localization of relevant machine locations as well as the identification of required spare parts.

In embodiments of the invention, constructive machine data (CAD data) is linked with the data that is collected or viewed (condition monitoring: cycle times, alarm and fault messages and sensor data) for display using 3D visualization techniques.

In embodiments of the invention, a control loop for “self-healing” machines is implemented.

In embodiments of the invention, a control loop is additionally set up using data technology and actuators, so that the diagnostics/analysis described above is supplemented by “self-healing”, self-regulating measures. Compared to conventional control loops, the invention is characterized in this respect by the combination of different data sources (cycle times, sensor data, alarm and fault messages), by the use of statistical procedures and ML methods and/or by local, regional or global benchmarking via the centrally established data pool.

In various embodiments of the invention, the methods of cycle time monitoring, sensor monitoring, evaluation of machine messages and monitoring of media consumption are realized with regard to the device according to the invention for acquiring measurement data of a machine, the method according to the invention for acquiring measurement data of a machine and a tire curing press according to the invention, in each case alone or in the various executable combinations.

Aspects of the invention are illustrated by way of example in the figures. They show:

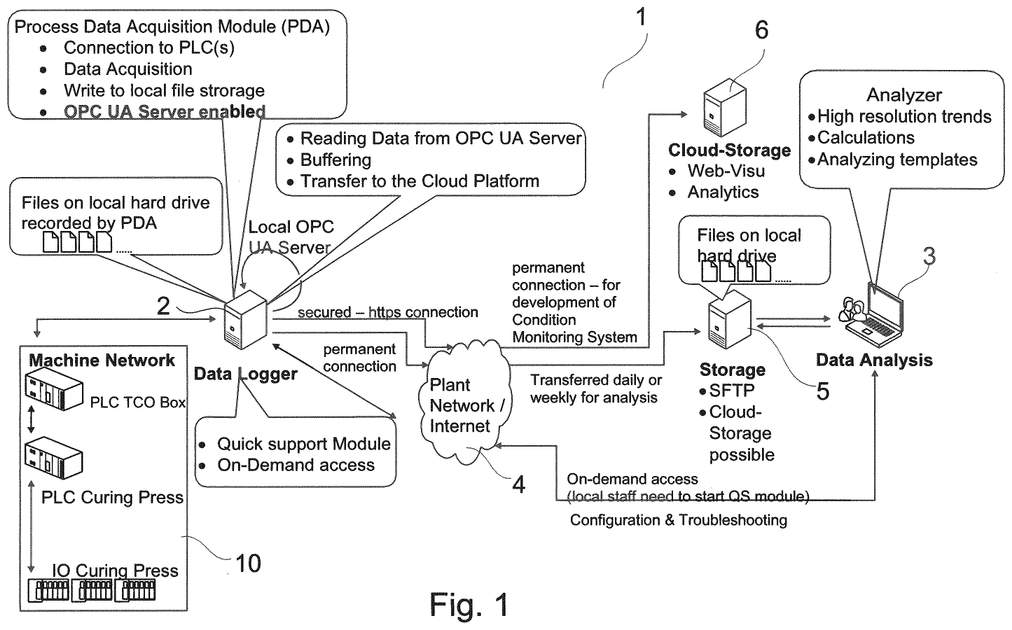

FIG. 1: A block diagram of an embodiment of a device for acquiring measurement data from a machine according to the invention,

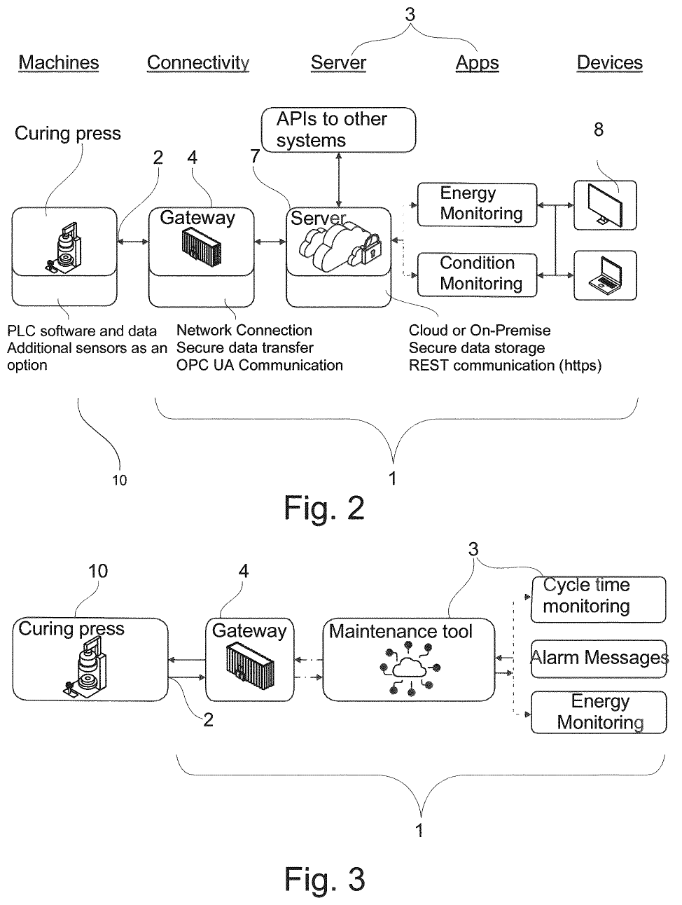

FIG. 2: A further block diagram of an embodiment of a device for acquiring measurement data from a machine according to the invention,

FIG. 3: A block diagram of a further embodiment of a device for acquiring measurement data from a machine according to the invention,

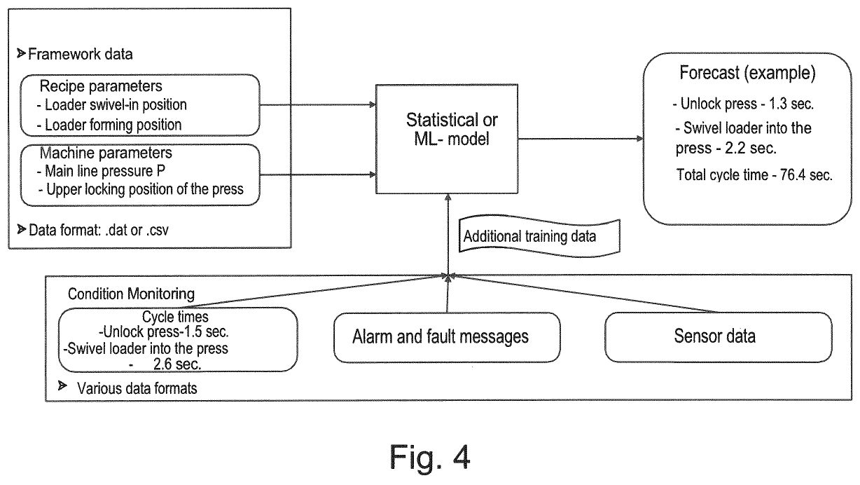

FIG. 4: A block diagram of functional modules of an embodiment of a method for acquiring measurement data of a machine according to the invention,

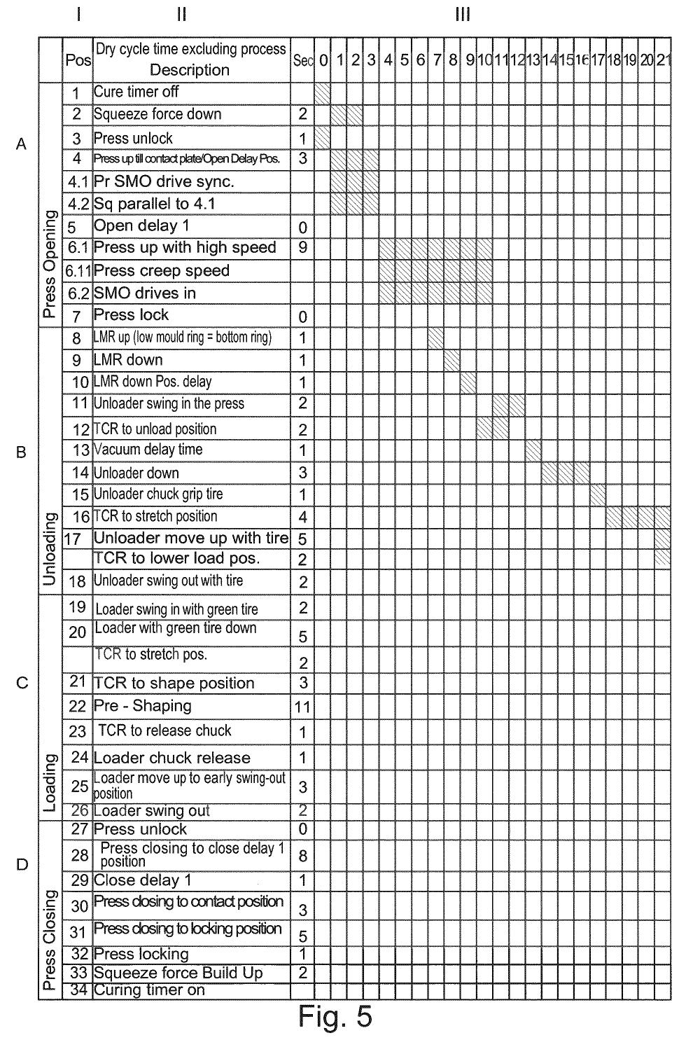

FIG. 5: A representation of a cycle time diagram with the individual phases of a cycle, individual movements each with sequence and specified target time,

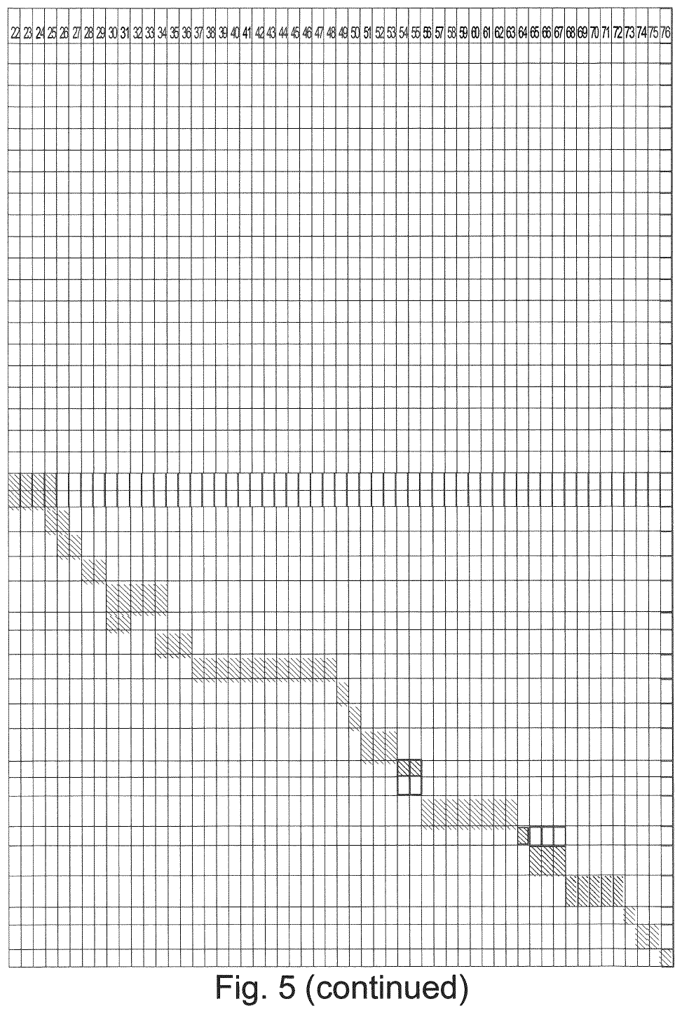

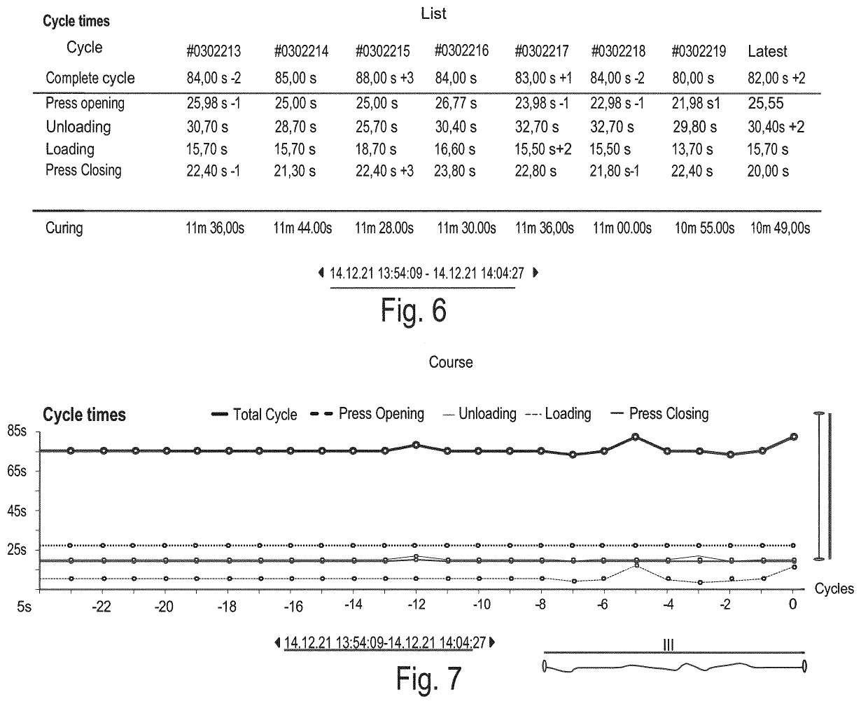

FIG. 6: A tabular representation of detected cycle times and phases with display of the deviations from the respective target value,

FIG. 7: A graphical representation of detected cycle times for the entire cycle and individual phases,

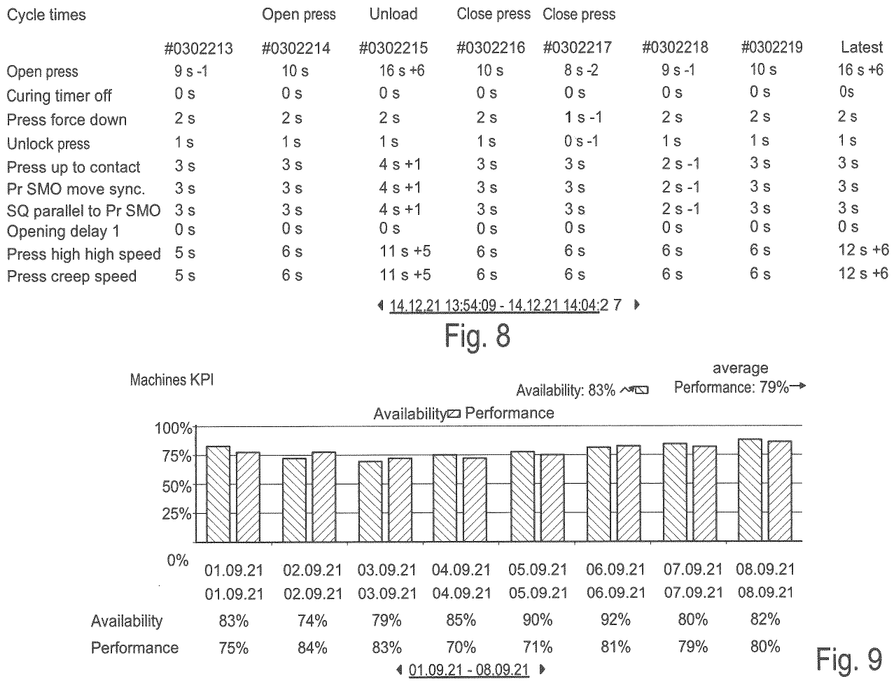

FIG. 8: A detailed tabular representation of detected cycle times and phases with display of the deviations from the respective target value,

FIG. 9: A representation of derived key figures for productivity and availability,

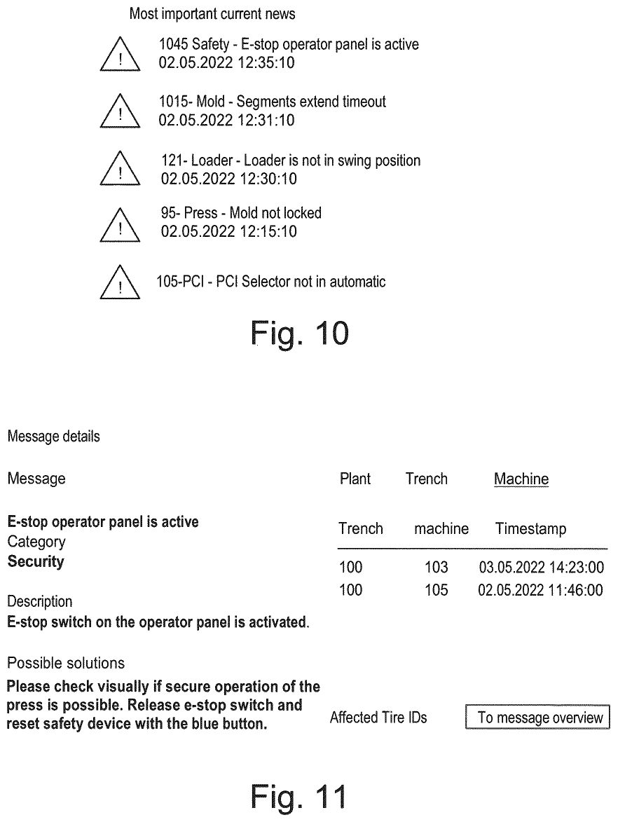

FIG. 10: An example of alarm and fault messages issued,

FIG. 11: An exemplary representation of details of an alarm or fault message and

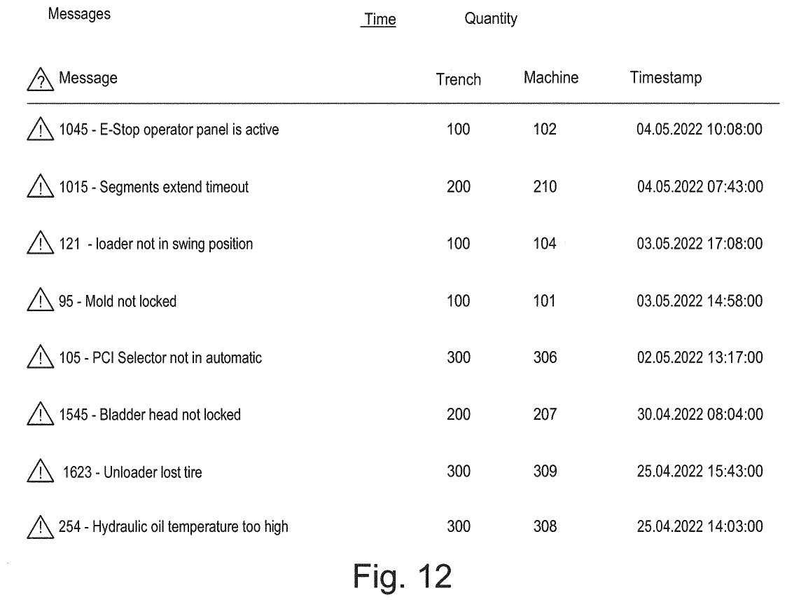

FIG. 12: A message overview for several machines with symbol for criticality, designation of machine location (trench), machine number and time stamp.

FIG. 1 shows an embodiment of a device (1) according to the invention for acquiring measurement data of a machine (10). The device (1) has a capturing device (2) for capturing at least one machine parameter and an evaluation unit (3) for evaluating the data captured with the aid of the capturing device (2) and carrying out condition monitoring.

The data captured by the capturing device (2) can be transmitted directly or indirectly to an evaluation unit (3) via a network (4). Indirectly means that the data is initially stored on a storage device (5). In addition, the captured data is stored in parallel in an external storage device (6), implemented here as a cloud storage.

In the example shown, the capturing device (2) accesses the machine control system to capture the machine data.

FIG. 2 shows a schematic block diagram of a device (1) according to the invention for acquiring measurement data of a machine (10) in an application with a tire curing press. The evaluation unit (3) is implemented using applications that run on a server (7). Outputs for the “energy monitoring” and “condition monitoring” functions can be output on output devices (8).

FIG. 3 schematically illustrates an application of the device (1) according to the invention for acquiring measurement data of a machine (10) as a digital maintenance tool, whereby information on the maintenance requirements of the monitored tire curing press is derived based on cycle time monitoring, the evaluation of machine messages and the monitoring of media consumption (in this case energy consumption).

FIG. 4 schematically shows the use of data and functions of the device (1) according to the invention for acquiring measurement data of a machine (10) in combination with a statistical model or a machine learning model to enable predictions to be made about the duration of cycles and subcycles of a tire curing press.

FIG. 5 shows a table in which the overall cycle of a tire curing press is divided into the various subcycles. The subcycles or process steps are listed in column Il and numbered in column I. The columns in block Ill visualize the duration of the individual subcycles and their chronological sequence. Furthermore, the subcycles are thematically assigned to the groups “Opening the tire curing press” (A), “Unloading the tire curing press” (B), “Loading the tire curing press” (C) and “Closing the tire curing press” (D).

FIG. 6 shows an output that can be generated automatically using a device (1) according to the invention for acquiring measurement data of a machine (10) in corresponding embodiments, which represents the respective duration and any deviations from the target time for various overall cycles identified by the respective cycle IDs, as well as the associated defined subcycles “Opening the tire curing press”, “Unloading the tire curing press”, “Loading the tire curing press” and “Closing the tire curing press” and the “Vulcanization process”. In other embodiments of the invention, corresponding outputs can be generated, for example, as a function of a product ID (e.g. tire ID), so that the information content can be adapted as required.

FIG. 7 shows a further output that can be generated automatically with the aid of a device (1) according to the invention for acquiring measurement data of a machine (10) in corresponding embodiments, whereby the information prepared in tabular form in FIG. 6 is shown graphically by means of curves.

FIG. 8 shows a further output that can be generated automatically using a device (1) according to the invention for acquiring measurement data of a machine (10) in corresponding embodiments, whereby the subcycle “opening the tire curing press” is divided into further subcycles corresponding to the individual process steps for opening the tire curing press. A corresponding detailed evaluation can also be retrieved for the other defined higher-level subcycles “unloading”, “loading” and “closing”.

FIG. 9 shows a further output that can be generated automatically with the aid of a device (1) according to the invention for acquiring measurement data of a machine (10) in corresponding embodiments, wherein the performance indicators “availability” and “performance” of a specific monitored machine are shown as a bar chart for various consecutive days.

FIG. 10 shows examples of various machine messages from a tire curing press that can be evaluated using corresponding embodiments of a device (1) according to the invention for acquiring measurement data from a machine (10).

FIG. 11 shows an output that can be generated automatically using a device (1) according to the invention for acquiring measurement data of a machine (10) in corresponding embodiments, whereby the category of the machine message (safety), a description of the machine message and suggestions for action to rectify the fault are output for a machine message “E-Stop operator panel is active”. Furthermore, in embodiments of the invention, machine messages that have occurred are linked to product IDs so that these products can be subjected to a targeted subsequent check if required.

FIG. 12 shows a further output that can be generated automatically with the aid of a device (1) according to the invention for acquiring measurement data of a machine (10) in corresponding embodiments, whereby the time and frequency of individual machine messages can be retrieved.

1-19. (canceled)

20. A device for acquiring measurement data of a tire curing press, the device being configured to monitor at least one tire curing press, the device comprising:
at least one capturing device configured to capture at least one machine parameter of the at least one monitored tire curing press; and at least one evaluation unit, wherein the at least one capturing device is configured to detect a cycle time required for carrying out a process cycle, and wherein the at least one evaluation unit is configured to monitor a condition of the at least one monitored tire curing press based on of the detected cycle time.

21. The device for acquiring measurement data of a tire curing press according to claim 20, wherein the process cycle comprises at least two process steps and wherein the at least one capturing device detects at least one subcycle time corresponding to a duration of a defined process step.

22. The device for acquiring measurement data of a tire curing press according to claim 21, wherein each subcycle corresponds to a defined machine movement or a sequence of machine movements of the at least one monitored tire curing press.

23. The device for acquiring measurement data of a tire curing press according to claim 21, wherein the at least one capturing device for detecting the cycle and/or subcycle times is configured to retrieve data from a machine control system and/or to evaluate machine messages and/or for sensor-based monitoring of the at least one monitored tire curing press.

24. The device for acquiring measurement data of a tire curing press according to claim 21, wherein the at least one evaluation unit is configured to retrieve stored setpoint values, tolerances and/or limit values of at least the cycle time, and is further configured to compare the detected real cycle and/or subcycle times with the setpoint values, tolerance ranges and/or limit values for the setpoint values and to detect a time deviation if at least one of the detected times falls outside the tolerance range of the setpoint values defined for the overall process and/or the respective process step or exceeds a respective limit value.

25. The device for acquiring measurement data of a tire curing press according to claim 24, wherein the at least one evaluation unit is additionally configured to retrieve stored setpoint values, tolerances and/or limit values of at the cycle time and all defined subcycles.

26. The device for acquiring measurement data of a tire curing press according to claim 24, wherein the at least one evaluation unit is configured to automatically detect a cause underlying the time deviation or to automatically delimit possible causes by assigning subcycles to specific process steps or machine movements.

27. The device for acquiring measurement data of a tire curing press according to claim 26, wherein the assigned possible causes are structured in cause lists and at least one criterion is assigned to each of the causes listed in the respective cause list, it being possible to determine from the check of the presence or absence of the at least one criterion whether the respective cause applies or can apply.

28. The device for acquiring measurement data of a tire curing press according to claim 24, wherein the at least one evaluation unit is configured to retrieve additional data in case of a detected deviation outside the tolerances so that, by the evaluation of the additional data, in conjunction with the detected time deviation, the cause can be automatically identified or at least further narrowed down.

29. The device for acquiring measurement data of a tire curing press according to claim 28, wherein the additionally retrievable data comprises sensor data and/or machine messages and/or media consumption in relation to the at least one monitored tire curing press and/or corresponding tire curing presses.

30. The device for acquiring measurement data of a tire curing press according to claim 29, wherein the evaluation of the additionally retrieved data in the form of sensor data, machine messages and/or media consumption by the evaluation unit enables an automatic check of criteria for the presence or absence of specific causes for detected time deviation(s).

31. The device for acquiring measurement data of a tire curing press according to claim 30, further comprising at least one communication device for connection to at least one additional data source and/or for transmitting data to a higher-level storage and/or evaluation unit.

32. The device for acquiring measurement data of a tire curing press according to claim 28, wherein the at least one evaluation unit is configured to automatically generate suggestions for eliminating the cause and/or to carry out an automated cause elimination based on the determined at least one cause or the determined possible causes for the at least one detected deviation and/or to output suggestions or instructions for further cause determination.

33. A tire curing press, comprising at least one device for acquiring measurement data according to claim 20.

34. A method for acquiring measurement data of at least one tire curing press, comprising the steps of:
a. Detecting at least one cycle and/or subcycle time of at least one monitored tire curing press;
b. Automated comparing of the at least one detected cycle and/or subcycle time with target values;
C. Automated detecting of a time deviation that exceeds defined tolerances; and
d. Performing automated condition monitoring of the at least one monitored tire curing press based on detected time deviations of the at least one cycle and/or subcycle time.

35. The method for acquiring measurement data of at least one tire curing press according to claim 34, further including automatically loading a cause list comprising possible causes for the detected deviation based on the at least one detected time deviation.

36. The method for acquiring measurement data of at least one tire curing press according to claim 35, including carrying out an automatic check of possible causes of the cause list for the detected time deviation using at least one criterion for unambiguous identification of the at least one cause or for narrowing down the cause list.

37. The method for acquiring measurement data of at least one tire curing press according to claim 36, including automatically retrieving suggestions for action and/or instructions for action for remedying the at least one identified cause and subsequently outputting the suggestions and/or instructions and/or carrying out an automated implementation of defined instructions for action for remedying the at least one cause.

38. The method for acquiring measurement data of at least one tire curing press according to claim 35, further including, parallel to the monitoring of the cycle and/or subcycle times or after the detection of a time deviation, automatically loading data from at least one additional data source and and using the data for automatic unambiguous identification of the at least one cause or for narrowing down the list of causes based on predetermined criteria.

39. The method for acquiring measurement data of at least one tire curing press according to claim 34, including using a device for acquiring measurement data of a tire curing press, the device being configured to monitor at least one tire curing press, the device comprising: at least one capturing device configured to capture at least one machine parameter of the at least one monitored tire curing press; and at least one evaluation unit, wherein the at least one capturing device is configured to detect a cycle time required for carrying out a process cycle, and wherein the at least one evaluation unit is configured to monitor a condition of the at least one monitored tire curing press based on of the detected cycle time.
